(19) United States
(12) Patent Application Publication
(10) Pub. No.: US 2026/0088513 A1
(43) Pub. Date: Mar. 26, 2026

(54) POWER DISTRIBUTION DEVICE, WAVEGUIDE ANTENNA, AND METHOD FOR MANUFACTURING A POWER DISTRIBUTION DEVICE

(71) Applicant: Robert Bosch GmbH, Stuttgart (DE)

(72) Inventors: Daniel Lopez Cuenca, Stuttgart (DE); Istvan Ther, Budapest (HU); Johannes Meyer, Ettlingen (DE); Julio Alberto Gonzalez Marin, Stuttgart (DE)

(21) Appl. No.: 19/111,542

(22) PCT Filed: Oct. 17, 2023
(86) PCT No.: PCT/EP2023/078825

§ 371 Date: Mar. 13, 2025

(30) Foreign Application Priority Data
Jan. 18, 2023 (DE) 10 2023 200 363.5

(51) Int. Cl. H01Q 13/00

(52) U.S. Cl. CPC H01Q 13/00

(57) ABSTRACT

A power distribution device for a waveguide antenna. The power distribution device has a plurality of waveguide sections including an input waveguide section, into which an electromagnetic wave can be coupled, and a plurality of feed waveguide sections. Each feed waveguide section feeds the electromagnetic wave into a respective radiating element of the waveguide antenna for radiating the electromagnetic wave. Each waveguide section has a rectangular cross-section with narrow and long sides. A branching point for power distribution is provided, at which an incoming waveguide section branches into at least two outgoing waveguide sections. The dimensions of the narrow side of the incoming and of the at least two outgoing waveguide sections differ at least partially from one another. The waveguide sections are arranged symmetrically with respect to a plane of symmetry, wherein the plane of symmetry is parallel to the narrow sides.

### FIELD

The present invention relates to a power distribution device for a waveguide antenna, a waveguide antenna, and a method for manufacturing a power distribution device.

### BACKGROUND INFORMATION

In a waveguide, electromagnetic energy is transported in a metallic cavity. The waveguide may be part of a waveguide antenna, wherein, in the simplest case, a slot is formed in the waveguide, which slot serves as an interface between the inner region of the waveguide and the free space, i.e., as a radiating element. This slot need not be completely parallel to the currents of the electromagnetic wave running through the waveguide.

Since a single slot has only a low directivity, waveguide antennas typically comprise multiple slots that form an antenna array. The simplest way to form a waveguide antenna array is to place the slots on the long side of a rectangular cross-section of the waveguide while maintaining a distance of half a wavelength so that a zig-zag structure is created relative to the center of the waveguide. Due to the zig-zag structure, all slots radiate with the same phase.

In the serial production of such waveguide antenna arrays using inexpensive methods, two metal parts are manufactured, which are then assembled. The waveguide channels can be arranged vertically in such cases, wherein the narrow side remains free for radiation. The two parts are connected in parallel with the narrow side of the waveguide so that the currents flowing through the waveguide are not disrupted. The two metal parts do not even need to have any galvanic contact, so that the guiding capability of the waveguide is influenced only marginally.

In order to make possible the required spacing between the radiating elements, U.S. Patent Application Publication No. US 2020/203841 A1 describes a centrally fed open waveguide antenna array, wherein the feeding waveguide is connected to elements formed by two apertures.

### SUMMARY

The present invention provides a power distribution device for a waveguide antenna, a waveguide antenna, and a method for manufacturing a power distribution device.

Preferred embodiments of the present invention are disclosed herein.

According to a first aspect, the present invention relates to a power distribution device for a waveguide antenna. According to an example embodiment of the present invention, the power distribution device has a plurality of waveguide sections comprising an input waveguide section, into which an electromagnetic wave can be coupled, and a plurality of feed waveguide sections, wherein each feed waveguide section is designed to feed the electromagnetic wave into a respective radiating element of the waveguide antenna for radiating the electromagnetic wave. The waveguide sections each have a rectangular cross-section with a narrow side and a long side. At least one branching point for power distribution is provided, at which branching point an incoming waveguide section branches into at least two outgoing waveguide sections. The waveguide sections are arranged symmetrically with respect to a plane of symmetry, wherein the plane of symmetry is parallel to the narrow sides of the rectangular cross-section of the waveguide sections.

According to a second aspect, the present invention relates to a waveguide antenna having a plurality of radiating elements designed to radiate an electromagnetic wave. Furthermore, the waveguide antenna comprises a power distribution device according to the first aspect, wherein the feed waveguide sections of the power distribution device are designed to feed the electromagnetic wave into a respective one of the radiating elements.

According to a third aspect, the present invention relates to a method for manufacturing a power distribution device. According to an example embodiment of the present invention, a first half of the power distribution device is manufactured. Furthermore, a second half of the power distribution device is manufactured. The two halves of the power distribution device are connected in the plane of symmetry of the power distribution device.

According to an example embodiment of the present invention, the power distribution device has a vertically symmetrical design, i.e., there is symmetry with respect to the vertical direction parallel to the long side of the rectangular cross-section of the waveguide sections. In the (horizontal) plane of symmetry, no or only very low currents flow. This makes it possible for the power distribution device to have a simpler design since a perfect galvanic connection is not required within this plane of symmetry.

The at least one branching point for power distribution makes it possible to distribute the power of the electromagnetic wave to outgoing waveguide sections, and thus ultimately to the feed waveguide sections. In this way, the amplitude can be adjusted; the phase of the radiated electromagnetic radiation can also be adjusted via the length of the waveguide sections.

The radiating elements of the waveguide antenna may be treated as independent elements and are supplied via the power distribution device with an electromagnetic wave with the required amplitude and phase. A specific amplitude distribution can thus be achieved at the radiating elements without breaking the vertical symmetry of the waveguides.

Furthermore, the radiating elements may be placed very close to one another, thereby minimizing side lobes in the antenna radiation pattern.

According to a further example embodiment of the power distribution device, the dimensions of the narrow side of the incoming and of the at least two outgoing waveguide sections differ at least partially from one another.

According to a further example embodiment of the power distribution device, the waveguide sections comprise at least one waveguide section designed as a quarter-wave impedance transformer. This can make an impedance adjustment at the at least one branching point possible without the waveguides having to be designed to be too wide.

According to a further embodiment of the power distribution device, for the at least one branching point, the sum of the dimensions of the narrow side of the rectangular cross-section of the at least two outgoing waveguide sections substantially corresponds to the dimension of the narrow side of the rectangular cross-section of the incoming waveguide section. In this way, the impedance at the branching point is adjusted.

According to a further example embodiment of the power distribution device, the dimension of the long side of the rectangular cross-section is identical for all waveguide sections. The power distribution device thus has a highly symmetrical design.

According to a further example embodiment of the power distribution device, the total lengths from a coupling area of the input waveguide section to a feed area of the feed waveguide sections differ by a whole number multiple of half a wavelength of the electromagnetic radiation (in empty space). This can reduce the occurrence of side lobes.

According to a further example embodiment of the power distribution device, the power distribution device is manufactured from two halves, which are connected to each other in the plane of symmetry. The connection thus takes place within the plane of symmetry, where no or only very low currents of the electromagnetic wave flow. The requirements for the manner in which the two halves are connected to each other can thus be greatly reduced. For example, a perfect galvanic connection between the two halves is not required, making the design much cheaper since no soldering process is necessary. According to a further embodiment of the power distribution device, a connection of the two halves of the power distribution device is therefore not galvanic. This may be understood to mean that the connection is non-conductive or at least only weakly conductive.

Further advantages, features and details of the present invention emerge from the following description, in which different embodiment examples of the present invention are described in detail with reference to the figures.

### BRIEF DESCRIPTION OF THE DRAWINGS

FIG. 1 shows a schematic oblique view of a waveguide antenna having a power distribution device according to an example embodiment of the present invention.

FIG. 2 shows a further schematic oblique view of the waveguide antenna shown in FIG. 1.

FIG. 3 shows a schematic cross-sectional view of the power distribution device of the waveguide antenna shown in FIGS. 1 and 2.

FIG. 4 shows a schematic oblique view of a waveguide section.

FIG. 5 shows a schematic oblique view of a branching point for power distribution for use in a power distribution device according to an embodiment of the present invention.

FIG. 6 shows a schematic top view of the branching point shown in FIG. 5.

FIG. 7 shows an equivalent circuit diagram of the branching point shown in FIGS. 5 and 6.

FIG. 8 shows a flow chart of a method for manufacturing a power distribution device for a waveguide antenna according to an example embodiment of the present invention.

In all figures, identical or functionally identical elements and devices are provided with the same reference signs. The numbering of method steps is for the sake of clarity and is generally not intended to imply a specific chronological order. It is in particular also possible to carry out multiple method steps simultaneously.

### DETAILED DESCRIPTION OF EXAMPLE EMBODIMENTS

FIG. 1 shows a schematic oblique view of a waveguide antenna 1 (or waveguide antenna array) having a power distribution device 3 and a plurality of radiating elements 21 to 24 designed to radiate an electromagnetic wave. The radiating elements 21 to 24 are designed as waveguide sections, which are closed on one side and open on the other side. The electromagnetic wave is radiated on the open side.

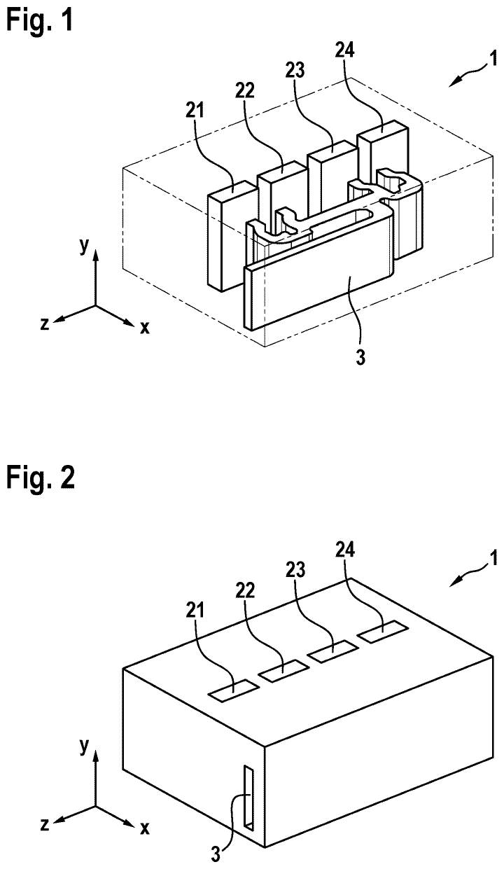

FIG. 2 shows a further schematic oblique view of the waveguide antenna 1 shown in FIG. 1, wherein the outer housing is shown.

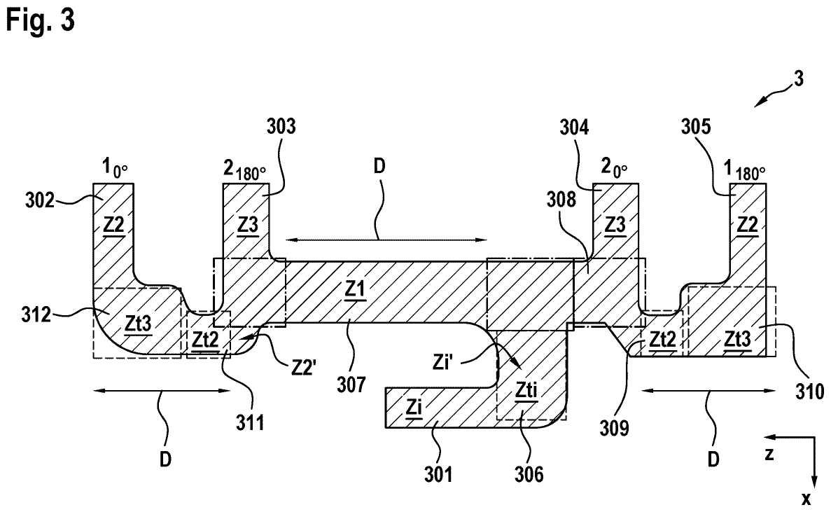

FIG. 3 shows a schematic cross-sectional view of the power distribution device 3 of the waveguide antenna shown in FIGS. 1 and 2. The power distribution device 3 comprises a plurality of waveguide sections 301-312. The waveguide sections 301-312 comprise an input waveguide section 301, into which an electromagnetic wave can be coupled or fed. Furthermore, the power distribution device 3 comprises four feed waveguide sections 302-305, via which the electromagnetic wave is fed into a respective radiating element 21-24, which then radiates the electromagnetic wave.

The present invention is not limited to a certain number of feed waveguide sections 302-305 or radiating elements 21 to 24.

Furthermore, the power distribution device 3 comprises multiple waveguide sections 306-312, which connect the input waveguide section 301 to the feed waveguide sections 302-305. The power distribution device 3 as a whole thus comprises multiple waveguide sections 301-312 connected to one another in a fluidic manner.

The waveguide sections 301-312 each have a rectangular cross-section with a narrow side (parallel to a horizontal xz-plane) and a long side (parallel to a vertical y-axis). The dimension of the long side of the rectangular cross-section is identical for all waveguide sections 301-312.

Multiple branching points are provided to distribute the electromagnetic wave fed into the input waveguide section 301 to the radiating elements 21 to 24, and are used for power distribution, e.g., they distribute the power of the electromagnetic wave. Each branching point comprises an incoming waveguide section 301-312 branching into two outgoing waveguide sections 301-312. The present invention is not limited thereto, but an incoming waveguide section 301-312 may also branch into more than two outgoing waveguide sections 301-312.

The dimensions of the narrow side of the incoming and of the at least two outgoing waveguide sections 301-312 differ at least partially from one another. Preferably, an impedance adjustment takes place at the branching points, i.e., the sum of the dimensions of the narrow sides of the outgoing waveguide sections 301-312 substantially corresponds to the dimension of the narrow side of the incoming waveguide section 301-312.

The waveguide sections 301-312 are all symmetrically arranged with respect to a common plane of symmetry, wherein the plane of symmetry is parallel to the narrow sides of the rectangular cross-section of the waveguide sections 301-312. The plane of symmetry is thus parallel to the xz-plane through the center of the power distribution device 3.

The power distribution device 3 is preferably manufactured from two halves, which are connected to each other in the plane of symmetry. The power distribution device 3 thus consists of a lower half and an upper half, which can be mirrored at the plane but otherwise have an identical design. Preferably, the halves are not galvanically connected, which simplifies manufacturing.

In the design shown in FIG. 3, the input waveguide section 301 (first waveguide section) with impedance Zi initially connects to a second waveguide section 306 designed as a quarter-wave impedance transformer with impedance Zti. This second waveguide section branches into two outgoing waveguide sections 307, 308 (third and fourth waveguide section, respectively). The branching point corresponds to a first power distributor. The impedance Z1 is the same for the two outgoing waveguide sections 307, 308 and is calculated from:

$${Zi}^{′} = 2 \cdot Z 1$$

$${Zi}^{′} = {Zti}^{2} / Zi$$

wherein Zi′ denotes the impedance at the incoming waveguide section 306.

The fourth waveguide section 308 branches into a third feed waveguide section 304 (a fifth waveguide section) with impedance Z3 and a sixth waveguide section 309 with impedance Zt2, to which a seventh waveguide section 310 with impedance Zt3 connects, wherein the sixth waveguide section 309 and the seventh waveguide section 310 are designed as quarter-wave impedance transformers. A fourth feed waveguide section 305 (an eighth waveguide section) with impedance Z2 connects to the seventh waveguide section 310.

Symmetrically, the third waveguide section 307 branches into a second feed waveguide section 303 (a ninth waveguide section) with impedance Z3 and a tenth waveguide section 311 with impedance Zt2, to which an eleventh waveguide section 312 with impedance Zt3 connects, wherein the tenth waveguide section 311 and the eleventh waveguide section 312 are designed as quarter-wave impedance transformers. A first feed waveguide section 302 (a twelfth waveguide section) with impedance Z2 connects to the seventh waveguide section 312.

The branching point corresponds to a second power distributor, wherein:

$$Z {2}^{′} = Z 2 \cdot Zt {2}^{2} / Zt {3}^{2}$$

$$Z 3 = 2 \cdot Z {2}^{′}$$

$$Z 1 = Z 3 + Z {2}^{′} ,$$

wherein Z2′ denotes the impedance toward the tenth waveguide section 311.

The length of the third waveguide section 307 corresponds to half a wavelength of the electromagnetic radiation, as do a combined length of the sixth and seventh waveguide sections 309, 310 and a combined length of the tenth and eleventh waveguide sections 311, 312.

This results in identical phases on the feed waveguide sections 302-305, wherein the second feed waveguide section 303 and the fourth feed waveguide section 305 are phase-shifted 180 degrees with respect to the first feed waveguide section 302 and the third feed waveguide section 304. The phase shift may be compensated by coupling on opposite sides of the radiating elements 302-305, as illustrated in FIG. 1, so that all radiating elements 302-305 radiate in phase.

The total lengths from the coupling area of the input waveguide section 301 to a feed area of the feed waveguide sections 302-305 thus differ by a whole number multiple of half the wavelength of the electromagnetic radiation.

The impedance transformations by means of the waveguide sections 306, 309, 310, 311, 312 designed as quarter-wave impedance transformers make it possible to achieve feasible impedances that cannot be achieved solely by changing the waveguide dimensions. For example, the impedance 22 is decreased by the factor (Zt2/Zt3)′ in order to achieve 22′. On the other hand, the input impedance is increased by Zti in order to achieve Zi′.

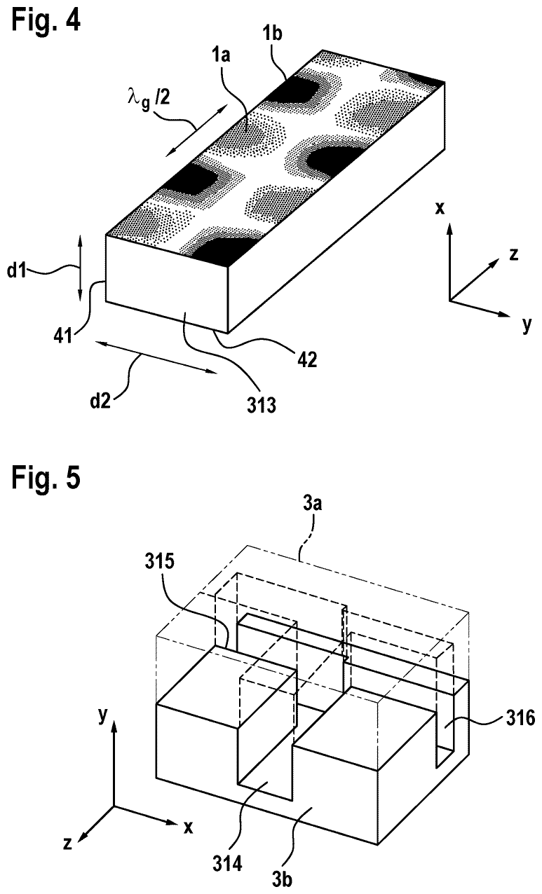

FIG. 4 shows a schematic oblique view of a waveguide section 313 having a rectangular cross-section in an xy-plane, wherein that of a waveguide section 313 extends along a z-axis. The maxima and minima of the amplitude of the electromagnetic wave in the y direction within the waveguide section 313 occur in outer areas 1a, 1b relative to the y-axis, i.e., in the area of the narrow ends of the waveguide. In an area 1c comprising the xz-plane through the center of the waveguide, the amplitude substantially disappears in the y direction. It is therefore advantageous to assemble the metal parts along the xz-plane through the center of the waveguide when assembling the waveguide from multiple metal parts, since the amplitude of the magnetic wave in this area substantially disappears in the y direction. The connection of the metal parts does not even need to be galvanic.

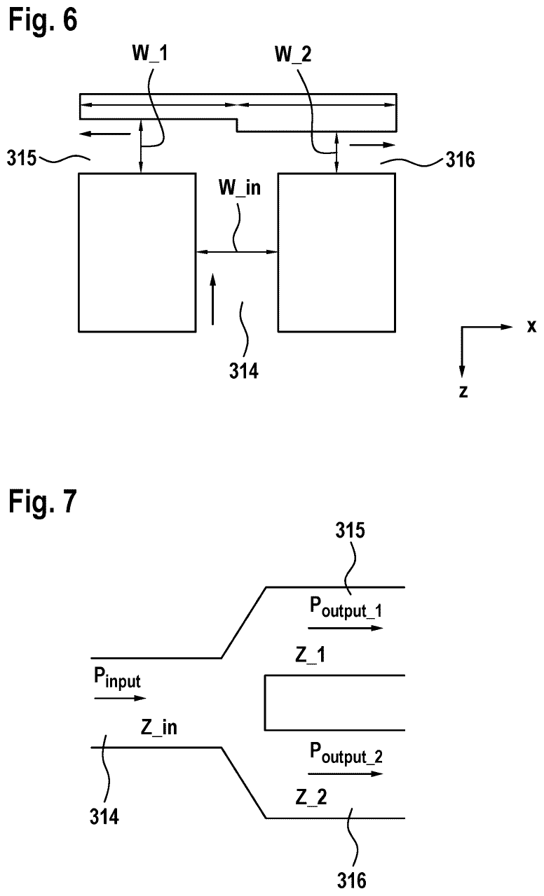

FIG. 5 shows a schematic oblique view of a branching point for power distribution for use in a power distribution device 3 constructed from a first half 3a and a second half 3b. FIG. 6 shows a schematic top view of the branching point shown in FIG. 5. An incoming waveguide section 314 branches into two outgoing waveguide sections 315, 316. A dimension W_in of the narrow side of the waveguide section 314 substantially corresponds to the sum of the dimension W_1 of the narrow side of the first outgoing waveguide section 315 and the dimension W_2 of the narrow side of the second outgoing waveguide section 316. The dimensions W_1, W_2 of the narrow sides of the two outgoing waveguide sections 315, 316 may differ from each other but may also be the same.

FIG. 7 shows an equivalent circuit diagram of the branching point shown in FIGS. 5 and 6. The power P_input of the incoming electromagnetic wave is divided into the powers P_output_1 and P_output_2 of the outgoing electromagnetic waves in a manner corresponding to the ratio of the impedances Z_in, Z_1, Z_2.

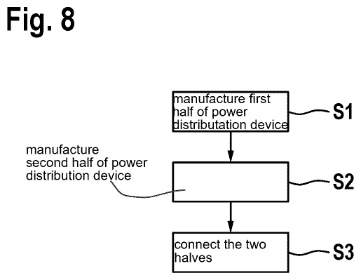

FIG. 8 shows a flow chart of a method for manufacturing a power distribution device 3 described above for a waveguide antenna 1.

In a first method step S1, a first half 3a of the power distribution device 3 is manufactured.

In a second method step S2, a second half 3b of the power distribution device 3 is manufactured.

In a third method step S3, the two halves of the power distribution device 3 are connected in the plane of symmetry of the power distribution device 3.

1-10. (canceled)

11. A power distribution device for a waveguide antenna, comprising:
a plurality of waveguide sections including an input waveguide section, into which an electromagnetic wave can be coupled, and a plurality of feed waveguide sections, wherein each of the feed waveguide sections is configured to feed the electromagnetic wave into a respective radiating element of the waveguide antenna for radiating the electromagnetic wave;
wherein the waveguide sections each have a rectangular cross-section with a narrow side and a long side;
wherein at least one branching point is provided for power distribution, at which branching point an incoming waveguide section branches into at least two outgoing waveguide sections; and
wherein the waveguide sections are arranged symmetrically with respect to a plane of symmetry, wherein the plane of symmetry is parallel to the narrow sides of the rectangular cross-section of the waveguide sections.

12. The power distribution device according to claim 11, wherein the waveguide sections include at least one waveguide section configured as a quarter-wave impedance transformer.

13. The power distribution device according to claim 11, wherein, for the at least one branching point, a sum of dimensions of the narrow side of the rectangular cross-section of the at least two outgoing waveguide sections substantially corresponds to a dimension of the narrow side of the rectangular cross-section of the incoming waveguide section.

14. The power distribution device according to claim 11, wherein a dimension of the long side of the rectangular cross-section is identical for all of the waveguide sections.

15. The power distribution device according to claim 11, wherein total lengths from a coupling area of the input waveguide section to a feed area of the feed waveguide sections differ by a whole number multiple of half a wavelength of the electromagnetic wave.

16. The power distribution device according to claim 11, wherein the power distribution device is manufactured from two halves connected to each other in a plane of symmetry.

17. The power distribution device according to claim 16, wherein a connection of the two halves of the power distribution device is not galvanic.

18. A waveguide antenna, comprising:
a plurality of radiating elements configured to radiate an electromagnetic wave; and
a power distribution device
a plurality of waveguide sections including an input waveguide section, into which an electromagnetic wave can be coupled, and a plurality of feed waveguide sections, wherein each of the feed waveguide sections is configured to feed the electromagnetic wave into a respective radiating element of the waveguide antenna for radiating the electromagnetic wave,
wherein the waveguide sections each have a rectangular cross-section with a narrow side and a long side,
wherein at least one branching point is provided for power distribution, at which branching point an incoming waveguide section branches into at least two outgoing waveguide sections, and
wherein the waveguide sections are arranged symmetrically with respect to a plane of symmetry, wherein the plane of symmetry is parallel to the narrow sides of the rectangular cross-section of the waveguide sections.

19. A method for manufacturing a power distribution device for a waveguide antenna, the power distribution device including:
a plurality of waveguide sections including an input waveguide section, into which an electromagnetic wave can be coupled, and a plurality of feed waveguide sections, wherein each of the feed waveguide sections is configured to feed the electromagnetic wave into a respective radiating element of the waveguide antenna for radiating the electromagnetic wave,
wherein the waveguide sections each have a rectangular cross-section with a narrow side and a long side,
wherein at least one branching point is provided for power distribution, at which branching point an incoming waveguide section branches into at least two outgoing waveguide sections, and
wherein the waveguide sections are arranged symmetrically with respect to a plane of symmetry, wherein the plane of symmetry is parallel to the narrow sides of the rectangular cross-section of the waveguide sections;
the method comprising the following steps:
manufacturing a first half of the power distribution device;
manufacturing a second half of the power distribution device; and
connecting the first and second halves of the power distribution device in the plane of symmetry of the power distribution device.

20. The method according to claim 19, wherein the first and second halves of the power distribution device are connected with a non-galvanic connection.
